(19) United States
(12) Patent Application Publication
(10) Pub. No.: US 2003/0112112 A1
(43) Pub. Date: Jun. 19, 2003

(54) Flyback transformer

(76) Inventors: Reiy Long Wang, Tao Yuan Hsien (TW); Chun Ming Liu, Tao Yuan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/014,500

(22) Filed: Dec. 14, 2001

(51) Int. Cl. H01F 27/29

(52) U.S. Cl. 336/192

(57) ABSTRACT

A flyback transformer includes a casing, a transformer assembly, and a focusing pack casing is provided. The transformer assembly has at least two conductive pins to be electrically connected together and the focusing pack casing has two corresponding conductive glue members in a desired connection manner for fittingly connecting the conductive pins. Short-circuiting problems due to a “floating” junction copper wire are eliminated since the junction copper wire is replaced with an internal circuit positioned on an inner surface of the focusing pack casing. Further, the present invention provides a flyback transformer more reliable than the prior art approach.

### BACKGROUND OF THE INVENTION

1. Field of the Invention

The present invention relates to the field of flyback transformers, and more particularly, to a flyback transformer having an improved focusing pack casing that can prevent short-circuiting and permit efficient assembling and steady operations.

2. Description of the Prior Art

FIG. 1 is an exploded diagram of a prior art flyback transformer (FBT). The flyback transformer typically comprises a casing 1, a transformer assembly 2, and a focusing pack casing 3. After being assembled together, the transformer assembly 2 is mounted into the casing 1, and the focusing pack casing 3 is mounted on a side of the casing 1 to connect the transformer assembly 2.

The transformer assembly 2 has two sets of connection portions 21 and 22. Typically, terminal 211 of the transformer assembly 2 is electrically connected to a conductive pin 212 by means of a junction copper wire 23. As shown in FIG. 1, the copper wire is “floating” in the air between the wire 24, which is in connection with the conductive pin 212, and the terminal 211. However, adequate spacing between the casing 1 and the transformer assembly 2 is required in order to avoid short-circuiting due to contact between the copper wire 23 and the casing 1. Further, to prevent short-circuiting from occurring, the copper wire 23 is usually cut into a length that approximately equal to the distance between the terminal 211 and the wire 24 connecting to a desired conductive pin 212. In this case, when one end of the copper wire 23 is soldered on the terminal 211, it is often not easy for an operator to solder the other end of the copper wire 23 onto the wire 24.

Consequently, there is a need to provide an improved flyback transformer design to solve the above-mentioned problems.

### SUMMARY OF THE INVENTION

It is therefore a primary object of the present invention to provide a flyback transformer to solve the above problems.

According to the claimed invention, the flyback transformer comprises a casing, a transformer assembly, and a focusing pack casing. The transformer assembly has at least two conductive pins to be electrically connected together and the focusing pack casing has two corresponding conductive glue members in a desired connection manner for fittingly connecting the conductive pins.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

FIG. 1 is an exploded diagram of a typical flyback transformer.

FIG. 2 is an exploded diagram depicting of a flyback transformer according to one preferred embodiment of this invention.

FIG. 3 is a perspective diagram showing the flyback transformer of FIG. 2 after assembling.

FIG. 4 is a cross sectional diagram of the flyback transformer of FIG. 3.

### DETAILED DESCRIPTION OF THE PREFERRED EMBODIMENT

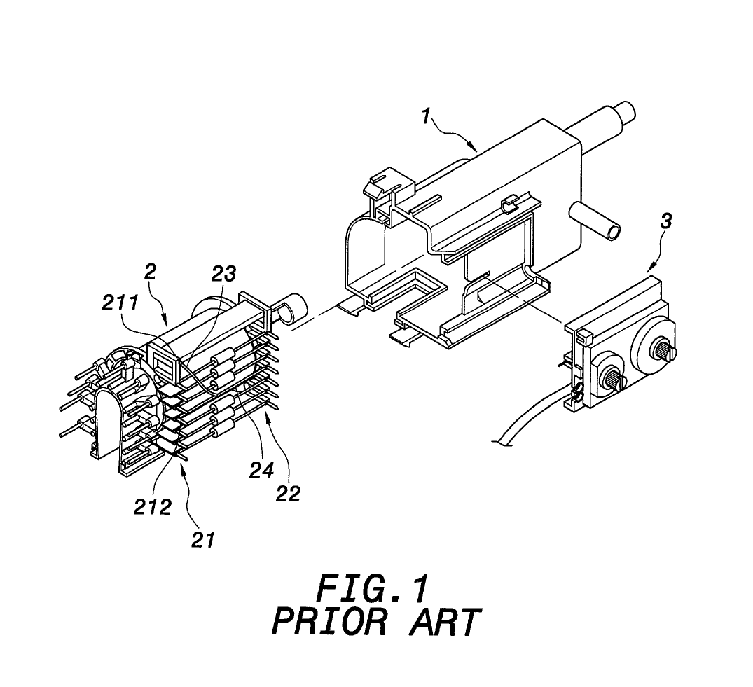

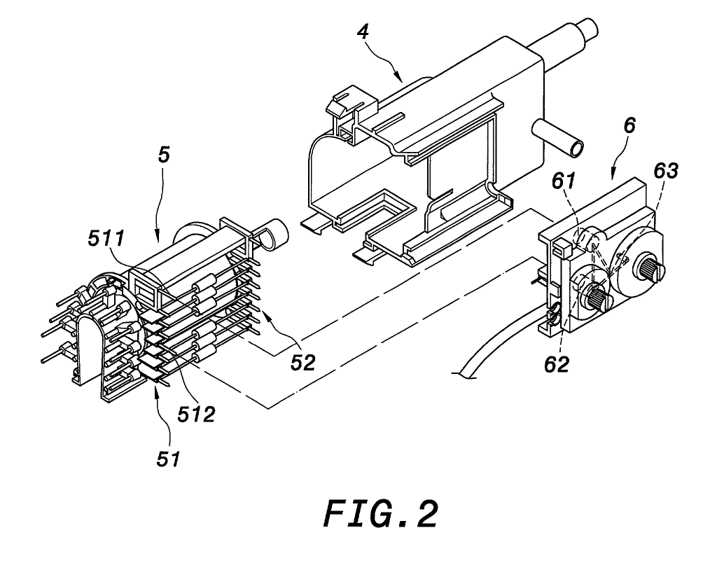

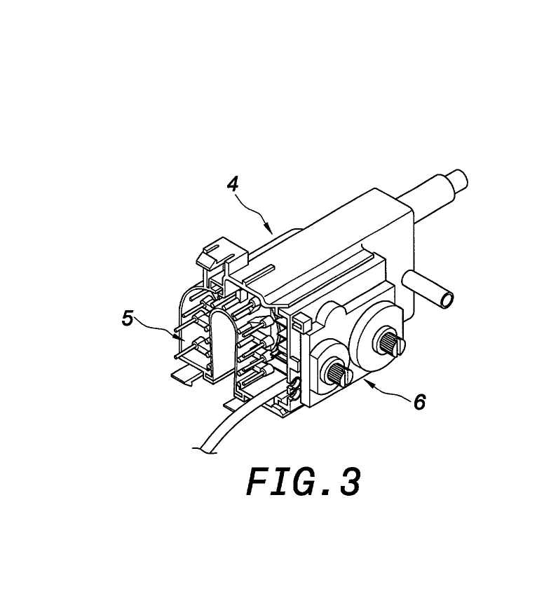

Please refer to FIG. 2 and FIG. 3. FIG. 2 is an exploded diagram depicting of a flyback transformer according to one preferred embodiment of this invention. FIG. 3 is a perspective diagram showing the flyback transformer of FIG. 2 after assembling. As shown in FIG. 2, the present invention provides a flyback transformer including a casing 4, a transformer assembly 5, and a focusing pack casing 6. A conductive pin 511 is substituted for the terminal 211 of FIG. 1. A conductive pin 512 of the connection portion 51 is also provided.

The focusing pack casing 6 has an inner surface that faces the transformer assembly 5 when assembled together. On the inner surface of the focusing pack casing 6 there are provided a conductive glue 61 and a conductive glue 62 (indicated in dash line) positioned in correspondence to the conductive pins 511 and 512, respectively. The conductive glue 61 and conductive glue 62 are connected to an internal circuit 63 to form an equivalent connection as prior art flyback transformer that utilizes a junction copper wire 23 to electrically connect with a terminal 211 and a wire 24.

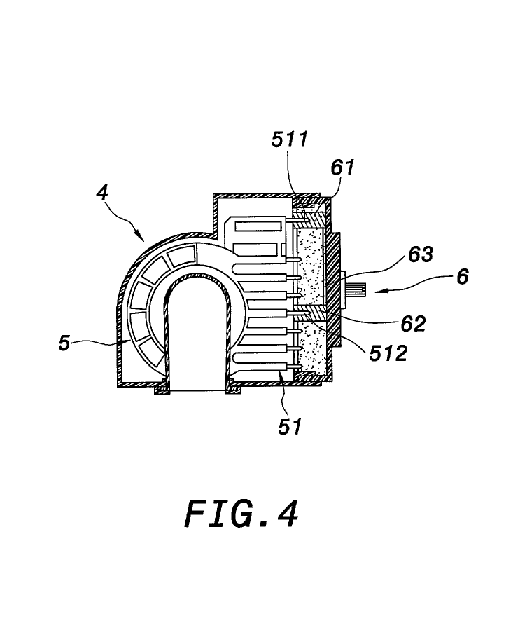

Please refer to FIG. 4 with respect to FIG. 3. FIG. 4 is a cross sectional diagram of the flyback transformer of FIG. 3. As shown in FIG. 3 and FIG. 4, the transformer assembly 5 is mounted into the casing 4. The focusing pack casing 6 is mounted on a side of the casing 4. When assembled together, the conductive glue 61 and conductive glue 62 on the inner surface of the focusing pack casing 6 are connected to the conductive pins 511 and 512, respectively. Further, by using the internal circuit 63 that connects the conductive glue 61 and conductive glue 62 on the inner surface of the focusing pack casing 6, the transformer 5 is able to connect to the focus components positioned on the focusing pack casing 6. By using the present invention, the prior art junction copper wire 23 is eliminated. Not to mention the troublesome soldering job.

The conductive glue 61, conductive glue 62, and the internal circuit 63 may be fixed by coating insulating glue (not shown) onto the inner surface of the focusing pack casing 6. When coating the insulating glue, the internal circuit 63 is covered, while a portion of the conductive glue 61 and conductive glue 62 is exposed.

As shown in FIG. 4, the conductive pins 511 and 512 of the transformer assembly 5 are inserted into associated conductive glue 61 and 62 mounted on the inner surface of the focusing pack casing 6. The internal circuit 63 is used to connect the conductive glue 61 and 62. In this way, it permits higher tolerance during manufacturing and assembling. Further, short-circuiting problems are eliminated since the internal circuit 63 is fixed on the inner surface of the focusing pack casing 6 and is isolated by the insulating glue.

In contrast to the prior art, this invention overcomes the drawbacks of the conventional approach. Short-circuiting problems due to a “floating” junction copper wire are eliminated since the junction copper wire is replaced with an internal circuit 63 positioned on an inner surface of the focusing pack casing 6. Further, the present invention provides a flyback transformer more reliable than the prior art approach.

Those skilled in the art will readily observe that numerous modification and alterations of the device may be made while retaining the teachings of the invention. Accordingly, the above disclosure should be construed as limited only by the metes and bounds of the appended claims.

What is claimed is:

1. A flyback transformer comprising a casing, a transformer assembly, and a focusing pack casing, characterized in that:
the transformer assembly has at least two conductive pins to be electrically connected together and the focusing pack casing has two corresponding conductive glue members in a desired connection manner for fittingly connecting the conductive pins.

2. The flyback transformer of claim 1, wherein two conductive glue members are electrically connected by means of an internal circuit.

3. The flyback transformer of claim 2, wherein the internal circuit is fixed by coating an insulating glue layer, while after coating the insulating glue layer, two conductive glue members are exposed.
